(19) United States
(12) Patent Application Publication
(10) Pub. No.: US 2001/0050141 A1
(43) Pub. Date: Dec. 13, 2001

(54) METHOD FOR PREPARING A FABRIC SUBSTANTIALLY CONSISTING OF CARBON FIBRES

(76) Inventors: ROBERT GERARDUS LENFERINK, TUBBERGEN (NL); WILHELMUS HENDRIKUS MARIA VAN DREUMEL, NIJVERDAL (NL)

Correspondence Address: RUSSELL D ORKIN, WEBB ZIESENHEIM BRUENING LOGSDON ORKIN, & HANSON, 700 KOPPERS BLDG-436 SEVENTH AVENUE, PITTSBURGH, PA, 152191818

(21) Appl. No.: 09/226,291

(22) Filed: Jan. 7, 1999

(30) Foreign Application Priority Data
Jan. 8, 1998 (NL) 1007987

(51) Int. Cl. B32B 5/02

(52) U.S. Cl. 156/334

(57) ABSTRACT

A method for preparing a fabric substantially consisting of carbon fibres for impregnation with a thermoplastic plastic comprises of:

a) providing a fabric which substantially consists of carbon fibres with a coating of an epoxy material without curer; and

(b) bringing and for a chosen time holding this fabric at an increased temperature such that the carbon fibres remain unaffected and the epoxy material is aged or neutralized and loses its tacky character.

Before glass fibres are formed into a fabric a protective coating is applied to the fibres. This coating is removed after the weaving by subjecting the glass fabric to a high temperature for quite a long time. A typical cycle comprises a temperature of about 400° C. for a period of 70 hours. The coating, generally designated as “strong layer”, usually consists of PVA (polyvinyl alcohol) or starch. During the heating process the protective coating is completely burned away, which can be easily checked by determining the weight of the fabric before and after the relevant heating treatment. In order to prepare glass fabric for impregnation after the heat treatment, a more suitable coating is added to the glass fibre material for adhesion to plastic systems. Typical materials for coatings are chromium (III) and siloxane complexes.

Lightweight composite materials for structural applications are manufactured by combining carbon fibres with a plastic matrix. For space travel, aviation and industrial applications the plastic is added to the fibres by an impregnation process. If the impregnation process is carried out on a fibre system in which all fibres run substantially parallel to each other, the product in question is designated as unidirectional tape.

Carbon fibres are easily damaged by friction forces. No protection for the carbon fibres is however necessary for the impregnation process for the unidirectional tape since no friction forces occur between the individual fibres.

If however the fibres are combined into a fabric, friction occurs between the fibres during insertion of the filling fibres perpendicularly of the warp fibres. As a result of these friction forces, carbon fibres are easily damaged during the weaving process.

In order to facilitate the weaving process carbon yarns are provided in advance by the supplier with a standard sizing, which consists for instance of 0.5-1% unsaturated epoxy material. This sizing does not have to be removed if the fabric is subsequently impregnated with a curing plastic system. The epoxy-based sizing is compatible with most thermosetting plastic systems. However, for impregnation with a thermoplastic matrix the epoxy sizing does have an adverse effect on the adhesion between fibre and plastic.

For these reasons material impregnated with a thermoplastic has only been made commercially available in the form of unidirectional tape. The manufacturing process of said unidirectional tapes uses fibres which are not provided with a coating or sizing. So as to enable weaving and nevertheless ensure sufficient adhesion between fibres and plastic, the epoxy sizing has to be neutralized after the weaving process.

Much attention has been devoted to this problem and the prior art is still seeking a method of removing or neutralizing the epoxy sizing on carbon fibres after the weaving process and is seeking to find a method to improve the adhesion between carbon and thermoplastic plastic and thus provide a basis for a reliable composite material for structural applications.

With a view to the above, the invention provides a method for preparing a fabric substantially consisting of carbon fibres for impregnation with a thermoplastic plastic, which method comprises the following steps of:

(a) providing a fabric which substantially consists of carbon fibres with a coating of an epoxy material without curer; and

(b) bringing and for a chosen time holding this fabric at an increased temperature such that the carbon fibres remain unaffected and the epoxy material is aged or neutralized and loses its tacky character.

In contrast to glass fibre, no additional sizing is added to the fibre material after the described thermal treatment. The epoxy sizing is still present after the thermal treatment, which can be determined by a weight comparison.

Although the epoxy coating is still present, the nature of the coating changes due to this process of artificial thermal ageing. The layer loses the reactivity and stickiness and forms a neutral base for adhesion to a thermoplastic plastic.

After the carbon fibres have been formed into a fabric, this fabric is brought to an increased temperature. This temperature must be high enough to neutralize the tacky epoxy resin and also low enough to ensure that the mechanical properties of the carbon fibres are not adversely affected.

A typical method can herein consist of step (b) being performed by holding the fabric first for (15±5) minutes at a temperature of (450±70)° C. and subsequently for (240±60) minutes at a temperature of (220±30)° C.

Another method can herein consist of step (b) being performed by holding the fabric for (180±60) minutes at a temperature of (380±50)° C.

A method in which the coating amounts to roughly 0.3-2% by weight of the fabric provides a very good compromise between the realization of desired effects and the use of relatively little epoxy material.

The invention also relates to a prepared fabric obtained by applying one or other of the above described methods. This fabric consists substantially of carbon fibres with a coating of aged or neutralized epoxy material.

The invention further relates to a method for manufacturing a laminate comprising a number of layers, consisting alternately of a prepared fabric according to the specification given in the previous paragraph and a layer of thermoplastic plastic, which laminate is formed by impregnating at increased temperature each layer of prepared fabric with the material of the layer of thermoplastic plastic, which impregnation takes place at increased temperature and optionally under increased pressure, wherein the layer of thermoplastic plastic can consist of a pre-manufactured foil, a powder-like or granular layer or is formed by co-extrusion.

A specific method herein consists of the thermoplastic plastic being semi-crystalline.

In a determined embodiment the method is performed such that the thermoplastic plastic is PPS (polyphenylene sulphide).

A preferred embodiment of the method for manufacturing a laminate has the special feature that the thermoplastic plastic is PPS (polyphenylene sulphide).

A greatly reduced viscosity facilitates the impregnation process.

The latter described method can advantageously have the special feature that said temperature amounts to (310±30)° C.

The crystalline character of the PPS can be adjusted by a method according to which the formed laminate is guided for cooling purposes over a cooling roller. It is possible to determine from the temperature of this cooling roller whether the thermoplastic plastic, in particular PPS, is amorphous or crystalline or a hybrid form therebetween. At temperatures below 160° C. the plastic is predominantly amorphous; above 160° C. the plastic is predominantly crystalline.

Finally, the invention relates to a laminate obtained by applying the method according to any of the claims 6-11, and comprising a number of layers consisting alternately of a prepared fabric according to claim 5 and a layer of thermoplastic plastic, which latter layer is impregnated into said prepared fabric.

1. Method for preparing a fabric substantially consisting of carbon fibres for impregnation with a thermoplastic plastic, which method comprises the following steps of:
(a) providing a fabric which substantially consists of carbon fibres with a coating of an epoxy material without curer; and
(b) bringing and for a chosen time holding this fabric at an increased temperature such that the carbon fibres remain unaffected and the epoxy material is aged or neutralized and loses its tacky character.

2. Method as claimed in claim 1, wherein step (b) is performed by holding the fabric first for (15±5) minutes at a temperature of (450±70)° C. and subsequently for (240±60) minutes at a temperature of (220±30)° C.

3. Method as claimed in claim 1, wherein step (b) is performed by holding the fabric for (180±60) minutes at a temperature of (380±50)° C.

4. Method as claimed in claim 1, wherein the coating amounts to roughly 0.3-2% by weight of the fabric.

5. Prepared fabric obtained by applying the method as claimed in any of the foregoing claims, which fabric consists substantially of carbon fibres with a coating of aged or neutralized epoxy material.

6. Method for manufacturing a laminate comprising a number of layers, consisting alternately of a prepared fabric as claimed in claim 4 and a layer of thermoplastic plastic, which laminate is formed by impregnating each layer of prepared fabric with the material of the layer of thermoplastic plastic, which impregnation takes place at increased temperature and optionally under increased pressure, wherein the layer of thermoplastic plastic can consist of a premanufactured foil, a powder-like or granular layer or is formed by co-extrusion.

7. Method as claimed in claim 6, wherein the thermoplastic plastic is semi-crystalline.

8. Method as claimed in claim 6, wherein the thermoplastic plastic is PPS (polyphenylene sulphide).

9. Method as claimed in claims 6 and 8, wherein the laminate is formed at a temperature at which the PPS material has a greatly reduced viscosity, for instance a viscosity comparable to the viscosity of water, for instance with a value in the range of 75-210 Pa.s.

10. Method as claimed in claim 9, wherein said temperature amounts to (310±30)°C.

11. Method as claimed in claim 9, wherein the formed laminate is guided for cooling purposes over a cooling roller.

12. Laminate obtained by applying the method as claimed in any of the claims 6-11, and comprising a number of layers consisting alternately of a prepared fabric as claimed in claim 5 and a layer of thermoplastic plastic, which latter layer is impregnated into said prepared fabric.
